(19) United States
(12) Patent Application Publication
(10) Pub. No.: US 2005/0130782 A1
(43) Pub. Date: Jun. 16, 2005

(54) Handheld power tool

(75) Inventor: Thomas Vollrath, Auggen (DE)

Correspondence Address: WATTS, HOFFMANN CO., L.P.A., Ste. 1750, 1100 Superior Ave., Cleveland, OH, 44114, US

(73) Assignee: Guenther Boehler GmbH.

(21) Appl. No.: 11/007,940

(22) Filed: Dec. 9, 2004

(30) Foreign Application Priority Data
Dec. 12, 2003 (DE) 10358350.5

(51) Int. Cl. F16H 3/72

(52) U.S. Cl. 475/5

(57) ABSTRACT

A machine tool having at least one motor-driven tool, having a gearing arrangement comprising a drive (1), a power-take-off (2), a first gear train (A) having a first directional clutch (3), by which the drive (1) is drive-connected to the power-take-off (2) whenever the drive (1) is rotated in a first direction (I), and a second gear train (B) having a second directional clutch (4), by which the drive (1) is drive-connected to the power-take-off (2) whenever the drive (1) is rotated in a second direction (II). The first and the second directional clutch (3, 4) are preferably realized as freewheels and arranged coaxially.

The invention relates to a machine tool which is to be hand-held and manually operated by a user, having at least one motor-driven power-take-off or tool, so-called “Handheld Power Tools”.

Machine tools of this type, which include, for example, power drills, sanders, hand-operated circular saws and the like, often have the drawback, especially in the “low-cost” range or in the case of appliances in a particularly handy format, that either a gearing is completely dispensed with, so that there is only one tool speed available, or else the tool speed is achieved by modifying the drive voltage of the respective electric drive motor. However, this solution is not feasible with all drive motors and is often unsatisfactory in terms of the torque behavior.

Multi-step speed-change gearings, of course, provide different tool speeds, but are relatively complicated, bulky and expensive. Furthermore, the manual switching is not without problems, since an operator, in order to change speed, must generally first wait for the drive motor to stop in order to avoid damaging the gearing. Alternatively, costly measures are necessary in order to allow safe switching under load.

Furthermore, the manufacturers of such machine tools face high cost pressure, so that production costs have to be reduced, as far as possible without inhibiting durability, operability and functioning.

The object of the invention is to provide a machine tool having at least one motor-driven power-take-off or tool, which is of simple construction, is cheap to make and offers at least two gears or steps.

As a solution, the invention proposes a machine tool having at least one motor-driven power-take-off or tool having the features of patent claim 1. Preferred embodiments are defined in the subclaims.

The invention accordingly relates to a machine tool having at least one motor-driven power-take-off or tool, having a drive motor, the direction of rotation of which is selectively adjustable, or having a drive input which can be coupled with such a drive motor, and a gearing arrangement disposed between the drive motor or drive input and the at least one power-take-off or tool, the gearing arrangement comprising: a drive coupled with the drive motor or drive input, a power-take-off coupled with the at least one power-take-off or tool, a first gear train (A) having a first directional clutch, by which the drive is drive-connected to the power-take-off whenever the drive is rotated in a first direction (I), and a second gear train (B) having a second directional clutch, by which the drive is drive-connected to the power-take-off whenever the drive is rotated in a second direction (II), the first and the second directional clutch being arranged coaxially.

The machine tool according to the invention, having at least one motor-driven power-take-off or tool in particular the gearing arrangement provided therein, offers the advantage that a shift between the at least two gears or gear trains or steps is achieved in a simple manner by reversing the direction of rotation of the drive. At least two power-take-off speeds are thus available, without the need for a mechanical shift between the gear trains. The shift of drive direction can be effected in an appliance by simple measures in respect of the respective drive motor, so that improper use of the gearing or of an appliance containing this gearing can be prevented in the gear change, since no mechanical change of gearwheels takes place. Since all the elements of the gearing are always engaged, wear and tear is significantly reduced. Moreover, a drive motor can run in a fixed, optimal speed range in both gears of the gearing.

Since the respective gear or the respective transmission step is selected by the interaction of the directional clutches, which are available as standardized components, for example in the form of freewheels or locking pawls, including in very cheap construction, the gearing as a whole can be made very cheaply.

Furthermore, the coaxial arrangement of the directional clutches in the gearing arrangement leads to a reduction in size and to an advantageous mass balance, which reduces the vibrations and thereby improves the ease of handling of the appliance and its working life, since vibrations, which are in any event harmful to the mountings, are reduced.

The invention is now explained by way of example for a preferred embodiment with reference to the appended drawing, in which:

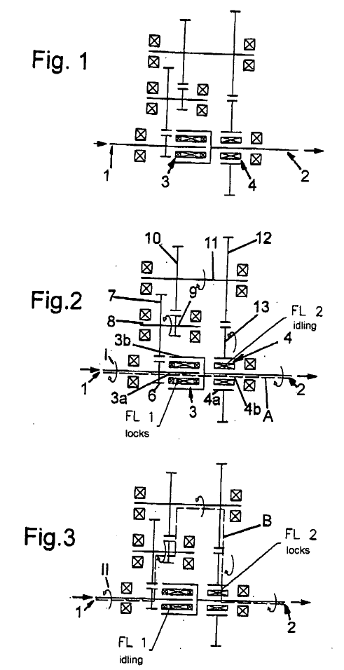

FIG. 1 shows a diagrammatic representation of a gearing arrangement used in the machine tool according to the invention,

FIG. 2 shows the gearing arrangement of FIG. 1 in operation in a first step and

FIG. 3 shows the gearing arrangement of FIG. 1 in operation in a second step.

The gearing arrangement according to the invention, shown in diagrammatic representation in the drawing, is constituted by a 2-gear or 2-step gearing, whose two gear trains A and B are respectively activated in dependence on the direction of rotation at the drive (1).

The first gear train A, which in the first step shown in FIG. 2 is activated, comprises a first directional clutch 3 (this is hereinafter always referred to as the “first freewheel”), whose drive member 3a is drive-connected, for torque-transmission purposes, to the drive 1 of the gearing arrangement. The power-take-off member 3b of the first freewheel 3 is drive-connected to the power-take-off member 4b of the second directional clutch 4 (this is hereinafter always referred to as the “second freewheel”). The first freewheel 3 is designed or fitted such that in the first step, in one direction of rotation I of the drive 1, it is in the locking state, i.e. transmits a torque from the drive member 3a to the power-take-off member 3b, and the second freewheel 4 is designed or fitted in an opposite or contra-rotating manner, so that, in this direction of rotation I, it is in the idling state, i.e. transmits no torque from the drive member 4a to the power-take-off member 4b. The direction of rotation at the power-take-off 2 of the gearing arrangement is thus the same as that at the drive 1. The term “drive-connected” used in this context should be taken to mean that the elements concerned are connected to one another directly or by interposed further elements such as intermediate shafts, friction-locking, positive and non-positive connections, etc. for torque-transmission purposes. This also incorporates the aspect that this connection can be interrupted temporarily, selectively or under certain conditions, for example by a clutch.

Located between the drive 1 and the drive member 3a of the first freewheel 3 there is a first gearwheel 6 engaged with a second gearwheel 7, which, in turn, is seated with a third gearwheel 9 on a common shaft 8. The third gearwheel 9 is engaged with a fourth gearwheel 10, which is seated with a fifth gearwheel 12 on a common shaft 11. Finally, the fifth gearwheel 12 is engaged with a sixth gearwheel 13, which is connected to the drive member 4a of the second freewheel 4. The first to sixth gearwheels 7 to 13 form the second gear train B, which, in the first step of the gearing arrangement, shown in FIG. 2, in the drive rotational direction I, is idling, i.e. revolves without torque transmission, since, at the second freewheel 4, which, in this direction of rotation I of the drive 1 (and, according to the representation in FIG. 2, in an opposite direction of rotation of the sixth gearwheel 13), is in the idling state, it is disconnected from the power-take-off 2 of the gearing arrangement. The intermediate shafts 8 and 11, and the drive and power-take-off shafts of the gearing arrangement, are mounted in mountings (not detailed) in a gear casing (not represented).

In the second step of the gearing arrangement, shown in FIG. 3, the second gear train B is activated whenever the drive 1 rotates in the opposite direction of rotation II. In this direction of rotation, the first freewheel 3 is, in fact, in the idling state and thus transmits no torque from its drive member 3a to its power-take-off member 3b and onward to the power-take-off member 4b of the second freewheel 4. In this opposite direction of rotation II of the drive 1, however, the second freewheel is in the locking state, so that the drive torque is transmitted from the drive 1 via the first gearwhell 6 and the second gear train B to the drive member 4a of the second freewheel 4 and from this to its power-take-off member 4b, and from this onward to the power-take-off 2 of the gearing arrangement. As a result of this design, the direction of rotation at the power-take-off 2 of the gearing arrangement is always the same, irrespective of the gear train active in each case and the direction of rotation at the drive 1. Although the second freewheel 4 can be located at any chosen place in the second gear train B and does not necessarily have to be aligned with the first freewheel 3, this solution is preferred according to the invention for imbalance correction reasons. According to the diagrammatic representation, not only the axles of the freewheels, but also the drive shaft and the power-take-off shaft of the gearing, are preferably arranged coaxially in order further to improve the imbalance correction. Furthermore, the freewheels are preferably directly coupled to one another by being seated, for example, one behind the other on or in a common shaft, so that the overall size and complexity of the gearing arrangement can be reduced.

Furthermore, the power-take-off 2 can not only have a single power-take-off shaft, as represented, but can also perfectly well have a plurality of power-take-off shafts running in the same or opposite directions, which are then, for mass balancing purposes, disposed symmetrically about the axles of the freewheels.

As a result of the sequence of the first to sixth gearwheels, the second gear train B has a speed-reducing and speed-increasing ratio which is different from the first gear train A, which, in the example, represents a direct coupling of drive 1 and power-take-off 2 via the first freewheel 3. This can, of course, be modified according to the application. A step-up or step-down of the drive can also be provided in the first gear train A. Furthermore, the torque transmission and the speed conversion in the gear trains can be effected, according to choice, using any types of friction-locking and positive-locking gearings and combinations thereof, i.e. gearwheels, friction wheels, chain and belt drives and the like, or using step-up and step-down mechanisms containing combinations of these elements. Finally, additional manually operated or automatic-working clutches can also be provided in the gear trains, if so desired.

The first and/or the second directional clutch 3,4 is/are preferably realized as roller freewheel, pawl freewheel, denture freewheel, friction freewheel, clamping freewheel, clamping element freewheel, wedging roller freewheel or as a back stop, various constructions being conceivable. For a gearing arrangement for use in a small machine tool, freewheels of the type HF 0406 KF and HFL 0406 KF (with antifriction mounting) from the company INA-Schaeffler KG can, for example, be used. For the directional clutches, the working of the rotational-direction-dependent switching between coupling or locking state and decoupling or idling state is of fundamental importance.

The gearing arrangement according to the invention is used in machine tools having one or more motor-driven tool(s), so-called “Handheld Power Tools”, such as hand drills, manual sanders and the like. In this case, electric motors or even pneumatic motors can be used as the motor drive. What is necessary, however, is the facility to shift the direction of rotation of the drive motor either electrically or mechanically, so that the drive of the gearing arrangement according to the invention can be selectively subjected to different directions of rotation in order thereby to achieve different gears, preferably with the same direction of rotation at the power-take-off or at the tool(s) connected thereto. In this context, the term “machine tool” should generally be taken to mean any appliance which has a motor drive or a corresponding input for a torque delivered by an external motor and in which the drive torque performs a work operation, two gears or speeds being required at the output(s) or tool(s). The motor and the gearing are, of course, accommodated in a known manner in a common casing (not shown). The term “tool” should be taken to mean any type of delivery of the power-take-off torque for the purpose of work performance and can also be realized merely as a “tool fixture”, to which the actual tool, for example such as in a power drill, sander, etc., must first be detachably fastened.

At the same time, the described embodiment represents the so-called “best mode of application” of the invention.

1. A machine tool having at least one motor-driven power-take-off or tool, having
a drive motor, the direction of rotation of which is selectively adjustable, or having a drive input which can be coupled with such a drive motor, and
a gearing arrangement disposed between the drive motor or drive input and the at least one power-take-off or too, the gearing arrangement comprising:
a drive (1) coupled with the drive motor or drive input, a
a power take-off (2) coupled with the at least one power-take-off or tool,
a first gear train (A) having a first directional clutch (3), by which the drive (1) is drive-connected to the power-take-off (2) whenever the drive (1) is drive-connected to the power-take-off (2) whenever the drive (1) is rotated in a second direction (II), wherein the first and the second directional clutch (3,4) are arranged coaxially.

2. The machine tool as claimed in claim 1, wherein the first direction clutch (3) and the second directional clutch (4) are disposed in contra-rotating arrangement.

3. The machine tool as claimed in claim 1, wherein the power-take-off member of the first directional clutch (3) is drive-connected to the power-take-off member of the second directional clutch (4).

4. The machine tool as claimed in claim 1, wherein the second gear train (B) has a speed-reducing and speed-increasing ratio which is different from the first gear train.

5. The machine tool as claimed in claim 1, wherein the first and/or the second gear train (A, B) is/are designed such that the direction of rotation at the power-take-off is the same, irrespective of the gear train which is active in each case.

6. The machine tool as claimed in claim 1, wherein the first and/or the second directional clutch (3,4) is/are realized as roller freewheel, pawl freewheel, denture freewheel, friction freewheel, clamping freewheel, clamping element freewheel, wedging roller freewheel or as a back stop.

7. The machine tool as claimed in claim 1, wherein the first and the second directional clutch (3, 4) and the drive (1), as well as the power-take-off (2) of the gearing arrangement, are arranged coaxially.
